(19) United States
(12) Patent Application Publication
(10) Pub. No.: US 2012/0240881 A1
(43) Pub. Date: Sep. 27, 2012

(54) MULTI-PART PISTON FOR AN INTERNAL COMBUSTION ENGINE

(75) Inventors: Rainer SCHARP, Vaihingen (DE); Klaus KELLER, Lorch (DE); Volker WEISSE, Stuttgart (DE); Sascha-Oliver BOCZEK, Dielheim (DE)

(73) Assignee: MAHLE INTERNATIONAL GMBH, Stuttgart (DE)

(21) Appl. No.: 13/489,825

(22) Filed: Jun. 6, 2012

Related U.S. Application Data
(62) Division of application No. 12/589,167, filed on Oct. 19, 2009.
Application No. 12/589,167 is a continuation-in-part of application No. 12/381,841, filed on Mar. 17, 2009, now Pat. No. 8,146,560.

(30) Foreign Application Priority Data
Nov. 5, 2008 (DE) 10 2008 055 912.1
Jul. 14, 2009 (DE) 10 2009 032 916.1

(51) Int. Cl. F01P 1/04; F16J 1/08

(52) U.S. Cl. 123/41.35

(57) ABSTRACT

A multi-part piston for an internal combustion engine has an upper piston part having a piston crown, and a lower piston part having pin boss supports and pin bosses connected with them. The upper piston part and lower piston part each have an inner and an outer support element, which delimit an outer circumferential cooling channel. The inner support elements delimit a cavity that is open toward the pin bosses, and the cavity is provided with a separate cooling oil collector that has at least one cooling oil opening.

### CROSS-REFERENCE TO RELATED APPLICATIONS

This is a divisional of U.S. patent application Ser. No. 12/589,167, which is a continuation-in-part of U.S. patent application Ser. No. 12/381,841, filed on Mar. 17, 2009, which claims priority from German Patent Application No. DE 10 2008 055 912.1, filed on Nov. 5, 2008, for which priority is also claimed under 35 U.S.C. §119. Applicants also claim priority under 35 U.S.C. §119 of German Patent Application No. DE 10 2009 032 916.1, filed on Jul. 14, 2009.

### BACKGROUND OF THE INVENTION

1. Field of the Invention

The present invention relates to a multi-part piston for an internal combustion engine, having an upper piston part that has a piston crown, and a lower piston part that has pin boss supports and pin bosses connected with them. The upper piston part and the lower piston part each have an inner and an outer support element, which elements delimit an outer circumferential cooling channel.

2. The Prior Art

A multi-part piston is disclosed, for example, in European Patent Application No. EP 1 222 364 B1. This piston has an outer circumferential cooling channel and an inner cooling chamber whose cooling chamber bottom is provided with an opening. This opening allows cooling oil to flow away out of the inner cooling chamber in the direction of the piston pin, in order to lubricate the piston pin and to intensify the cooling effect by effective cooling oil circulation. In order to achieve this goal, the opening in the cooling chamber bottom cannot be too large, because then, the cooling oil would no longer flow away in a metered manner, and effective cooling oil circulation would thereby be impaired. This means that the cooling chamber bottom is configured essentially as a relatively wide and thin circumferential ring land that extends approximately in the radial direction, in the upper region of the lower piston part. However, such a structure is difficult to produce. In the case of a forged lower piston part, in particular, there is the additional problem that when using a forging method, only a very thick and heavy cooling chamber bottom can be produced, due to forging tolerances and production restrictions.

### SUMMARY OF THE INVENTION

It is therefore an object of the present invention to provide a multi-part piston as well as a method for its production, which guarantees a good cooling effect of the cooling oil as well as effective lubrication of the piston pin, and, at the same time, is as simple as possible to produce as a light piston, also in the form of a forged piston.

This object is achieved by a multi-part piston for an internal combustion engine that has an upper piston part having a piston crown, and a lower piston part having pin boss supports and pin bosses connected with them. The upper piston part and lower piston part each have an inner and an outer support element, which delimit an outer circumferential cooling channel. According to the invention, the inner support elements delimit a cavity that is open toward the pin bosses, and the cavity is provided with a separate cooling oil collector that has at least one cooling oil opening.

The method according to the invention has the following method steps: producing an upper piston part having a piston crown as well as an inner and an outer support element, producing a lower piston part having pin boss supports and pin bosses connected with them, as well as having an inner and an outer support element; inserting a separate cooling oil collector having at least one cooling oil opening, into the upper piston part or the lower piston part; connecting the upper piston part and the lower piston part in such a manner that the inner and outer support elements, in each instance, delimit an outer circumferential cooling channel and a cavity that is open toward the pin bosses and provided with the cooling oil collector.

According to the invention, an inner cooling chamber and thus a cooling chamber bottom in the piston are therefore eliminated. The problem of producing a circumferential ring land that extends approximately in the radial direction, as a relatively wide and thin region, is therefore completely eliminated. The upper piston part and the lower piston part of the piston according to the invention can therefore also be produced as forged parts, in a relatively simple manner, and as comparatively light components. The piston according to the invention and the production method according to the invention therefore have clearly improved economic efficiency. In this connection, the cooling oil collector serves to optimize the cooling effect of the cooling oil, particularly below the piston crown. The at least one cooling oil opening in the cooling oil collector also allows significantly better and more precise metering of the cooling oil that flows away in the direction of the piston pin, so that the lubrication of the piston pin is also improved, as compared with the pistons known in the state of the art. Since the cooling oil collector can be produced and installed as a very simply structured and light component, the economic efficiency of the piston according to the invention, and of the production method according to the invention, remains unimpaired.

In a preferred embodiment of the piston according to the invention, the cooling oil collector is held on or rests on the lower piston part in the region of the inner support element. In this position, the cooling oil collector can rest on the pin boss supports, if applicable, and is thereby additionally fixed in place.

In a preferred embodiment, a holding element that extends vertically in the direction of the lower piston part, from the underside of the piston crown, is provided in the cavity; the cooling oil collector supports itself, with force fit and/or shape fit, against this element, in the axial direction. With this measure, as well, additional fixation of the holding element in the direction of the piston axis is achieved.

For this purpose, the cooling oil collector can have a hat-shaped elevation that interacts with the holding element. This elevation imparts additional stability to the cooling oil collector.

The holding element can be formed onto the underside of the piston crown, in one piece with it. However, it can also be configured as a separate element, and held on the underside of the piston crown with force fit and/or shape fit. The selection is at the discretion of a person skilled in the art, and allows flexible adaptation of the piston properties to the requirements in operation, in each instance.

If the holding element is configured as a separate component, it can be pressed onto the underside of the piston crown after assembly of the piston according to the invention, for example, or it can be connected with the underside of the piston crown using a pin connection or screw connection. These methods of construction are particularly easy to implement.

Independent of how the holding element is connected with the underside of the piston crown, the end of the holding element that faces the lower piston part, for example, can have a circumferential contact shoulder that surrounds a projection, for example, which shoulder rests on the cooling oil collector. The projection engages into a bore provided in the cooling oil collector. The projection can be configured as a journal, and the holding element can be riveted to the cooling oil collector by means of this journal. In this embodiment, the shape-fit connection between holding element and cooling oil collector offers a particularly reliable, stable hold.

It is practical if the length of the holding element is dimensioned in such a manner that the cooling oil collector is firmly supported on the inner support element and/or on the pin boss connection, and thus no longer has any lateral play. In this way, the cooling oil collector is positioned particularly firmly on the lower piston part.

For the purpose of further stabilization of the cooling oil collector, the cooling oil collector can have a flange that runs at least partially on the circumference, or tongues disposed at least on the outer edge, which lie against the inner support element and bring about additional friction fit.

The lower piston part and the upper piston part can be connected with one another, at least by way of their inner support elements, for example, by means of a method that produces friction weld beads. Preferably, the flange or the tongues are bent axially upward, and either touch the friction weld bead or rest against it or engage behind it. In this manner, particularly reliable securing of the position of the cooling oil collector in the cavity, able to withstand stress, is achieved.

Additional securing of the position of the cooling oil collector can be achieved, by a resilient support element on a side of the cooling oil collector facing the piston crown, which element supports itself on the underside of the piston crown.

In a preferred embodiment, the support element can have at least two, preferably three, but also more than three spring arms that support themselves on the underside of the piston crown.

The cooling oil collector and the support element can be configured in one piece or in multiple pieces. If multiple pieces are used, the support element can be attached to the cooling oil collector in any desired manner, for example by means of screwing, riveting, pressing, welding, soldering and the like.

The cooling oil collector can be made from any desired material, but it is practical if the collector is configured as an at least partially spring-elastic component. In this case, it can be held in one of the two components before the upper piston part and the lower piston part are connected, under spring bias. A suitable material is, for example, a spring steel sheet. In this case, the length of the holding element should be dimensioned accordingly.

In the simplest case, the cooling oil collector has an essentially round shape and can be provided with a slight curvature.

The at least one cooling oil opening in the cooling oil collector can be configured as a usual, round opening, or, for example, as a slit that is disposed at the edge of the cooling oil collector or extends inward from the edge of the cooling oil collector. The cooling oil collector preferably has two or more cooling oil openings, so that a very precisely metered amount of cooling oil can flow out of the cavity in the direction of the piston pin.

The upper piston part and/or the lower piston part can be cast parts or forged parts, and can be produced, for example, from a steel material, particularly forged steel. The connection between the upper piston part and lower piston part can be produced in any desired manner. Welding, particularly friction welding, is a particularly suitable joining method.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a section through a first embodiment of a piston according to the invention;

FIG. 2 shows a section through another embodiment of a piston according to the invention;

FIG. 3 shows a section through another embodiment of a piston according to the invention;

FIG. 4 shows a section through another embodiment of a piston according to the invention;

FIG. 5 shows a perspective representation of the cooling oil collector according to FIGS. 3 and 4; and

FIG. 6 shows an enlarged representation of a detail from FIG. 3.

### DETAILED DESCRIPTION OF THE PREFERRED EMBODIMENT

Referring now in detail to the drawings, FIG. 1 shows a first embodiment of a piston 10 according to the invention. Piston 10 is composed of an upper piston part 11 and a lower piston part 12, which are forged from a steel material. Upper piston part 11 has a piston crown 13 having a combustion bowl 14, as well as a circumferential top land 15 and a circumferential ring belt 16. Lower piston part 12 has a piston skirt 17 and pin bosses 18 having pin bores 19, for accommodating a piston pin (not shown).

Upper piston part 11 has an inner support element 21 and an outer support element 22. Inner support element 21 is disposed on the underside of piston crown 13, circumferentially, in ring shape, and has a joining surface 23. Outer support element 22 of upper piston part 11 is formed below ring belt 16, in the exemplary embodiment, and has a joining surface 24.

Lower piston part 12 also has an inner support element 25 and an outer support element 26. Inner support element 25 is disposed on the top of lower piston part 12, circumferentially, and has a joining surface 27. Outer support element 26 is formed as an extension of piston skirt 17, and has a joining surface 28. Pin boss supports 32 for connecting pin bosses 18 are provided below inner support element 25 of lower piston part 12.

Upper piston part 11 and lower piston part 12 can be joined in any desired manner, whereby joining surfaces 23 and 27, and 24 and 28, respectively, are connected with one another. In the embodiment shown, upper piston part 11 and lower piston part 12 were welded together.

Upper piston part 11 and lower piston part 12 form an outer circumferential cooling oil channel 29. In this connection, ring belt 16 and outer support element 22 of upper piston part 11 as well as outer support element 26 of lower piston part 12 delimit outer cooling channel 29 toward the outside. Inner support element 21 of upper piston part 11 and inner support element 25 of lower piston part 12 delimit outer cooling channel 29 toward the piston interior. Inner support element 21 of upper piston part 11 and inner support element 25 of lower piston part 12 furthermore delimit a cavity 31 that is open toward pin bosses 18, which cavity is disposed essentially below piston crown 13.

In the embodiment shown, cooling oil channels 33 are provided in inner support element 21 of upper piston part 11, which connect outer cooling channel 29 with cavity 31. Cooling oil channels 33 run at an angle downward, in the direction of cavity 31, proceeding from outer cooling channel 29. Of course, the cooling oil channels can also be disposed exclusively or additionally in inner support element 25 of lower piston part 12, and/or can run at an angle upward, in the direction of cavity 31, proceeding from outer cooling channel 29.

Cavity 31 is provided with a cooling oil collector 35. Cooling oil collector 35 is produced from a spring steel sheet, has an essentially round shape, is provided with a slight curvature, and has a thickness of approximately 0.8 mm. It has a circumferential spring-elastic flange 36 and cooling oil openings 37. Flange 36 is provided with slits 38, which both increase the elasticity of flange 36 in the radial direction and serve as additional cooling oil openings. Furthermore, cooling oil collector 35 is disposed in such a manner that its curvature is directed toward upper piston part 11.

A holding element 41, which is configured as a separate component and consists of a metallic material, projects into the cavity 31 vertically in the direction of lower piston part 12, proceeding from the underside of piston crown 13, in the center axis M of piston 10. At its free end that projects into cavity 31, holding element 41 has a projection 44 that is surrounded by a circumferential contact shoulder. Projection 44 passes through a center bore 43 provided in cooling oil collector 35, whereby the contact shoulder lies on the top of cooling oil collector 35. Projection 44 is configured as a journal, and holding element 41 is riveted to cooling oil collector 35 by means of this journal. At its free end facing piston crown 13, holding element 41 rests firmly against the underside of piston crown 13. The length of holding element 41 is dimensioned in such a way that cooling oil collector 35 supports itself on inner support element 25 or on pin boss supports 32, under spring bias, whereby flange 26 lies against inner support element 25 and brings about an additional friction fit between cooling oil collector 35 lower piston part 12. Cooling oil collector 35 is therefore held in a particularly secure and play-free manner.

Cooling oil collector 35 collects the cooling oil that passes through cooling oil channels 33, out of outer cooling channel 29, into cavity 31, and guides it in the direction of the underside of piston crown 13, particularly by means of the shaker effect that occurs during operation, in order to increase the cooling effect in this region. Cooling oil openings 37, 38 make it possible to guide a defined amount of cooling oil in the direction of the piston pin (not shown) accommodated in pin bores 19, in order to improve its lubrication.

For assembly of piston 10 according to the invention, first upper piston part 11, lower piston part 12, cooling oil collector 35, and holding element 41 are produced as separate components. Then, holding element 41 is riveted to the cooling oil collector. Cooling oil collector 35 is inserted into lower piston part 12, in the region of inner circumferential support element 25, and held there under spring bias, with force fit. Subsequently, upper piston part 11 and lower piston part 12 are connected with one another, by any joining method that is selected, by way of joining surfaces 23, 27 and 24, 28, respectively, in such a manner that cooling oil collector 35 is accommodated in cavity 31 in the finished piston, and that holding element 41 is pressed against the underside of piston crown 13, so that it is held with force fit there. For stabilization, a recess in the shape of a flattened dome or cone, for example, can be provided on the underside of piston crown 13, into which holding element 41 engages.

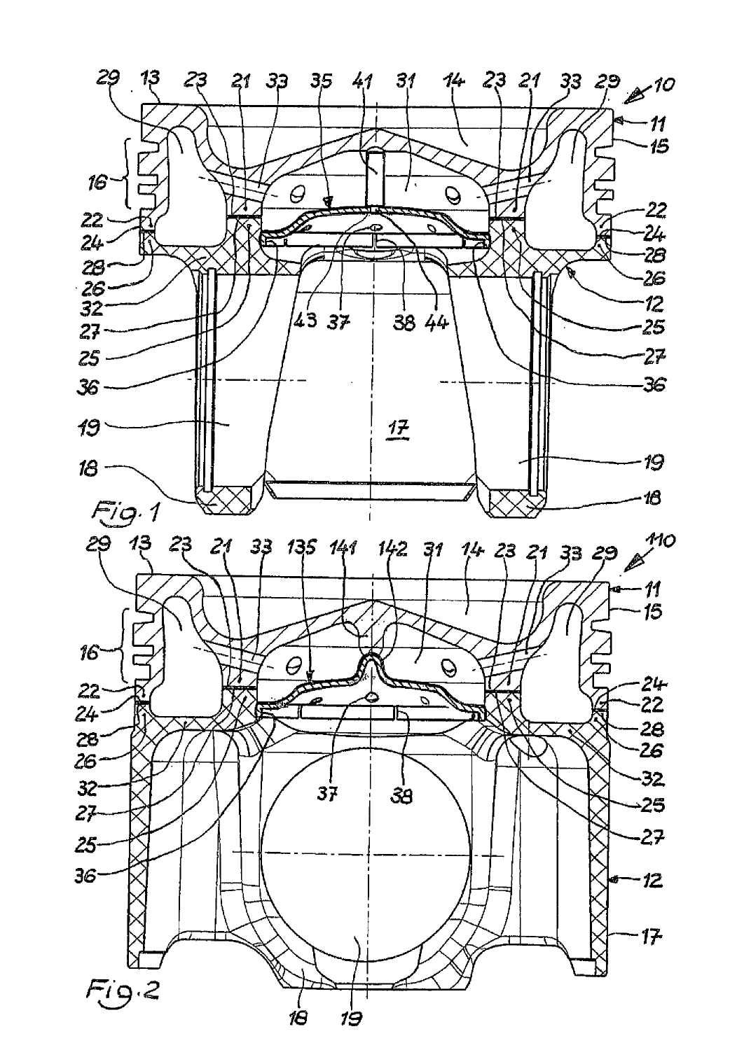

FIG. 2 shows another embodiment of a piston 110 according to the invention. Piston 110 is identical in construction, in essential parts, with piston 10 according to FIG. 1, so that the same structures are provided with the same reference numbers, and reference is made to the description of FIG. 1 with regard to these reference numbers.

A significant difference as compared with piston 10 according to FIG. 1 is that with piston 110, holding element 141 is formed on, in one piece, on the underside of piston crown 13, on lower piston part 111. Furthermore, cooling oil collector 135 has a hat-shaped elevation 142, which interacts with the free end of holding element 141. The length of holding element 141 is dimensioned in such a way that cooling oil collector 135 supports itself on inner support element 25 or on pin boss supports 32, under spring bias. Flange 26 lies against inner support element 25 and brings about an additional friction fit between cooling oil collector 135 and lower piston part 12. Thus, cooling oil collector 135 is held in particularly secure and play-free manner.

Of course, the cooling oil collector in both embodiments can also consist of a non-resilient, preferably metallic material, and be held in lower piston part 12 with force fit.

For assembly of piston 110 according to the invention, first upper piston part 111 with holding element 141 formed onto it in one piece, lower piston part 12, and cooling oil collector 135 are produced as separate components. In the embodiment shown, cooling oil collector 135 is inserted into lower piston part 12, in the region of the inner circumferential support element 25, and held there under spring bias, with force fit. Subsequently, upper piston part 111 and lower piston part 12 are connected with one another, by any joining method that is selected, by way of joining surfaces 23, 27 and 24, 28, respectively, so that cooling oil collector 135 is accommodated in cavity 31 in the finished piston, and that holding element 141 is pressed against hat-shaped elevation 142 of cooling oil collector 135.

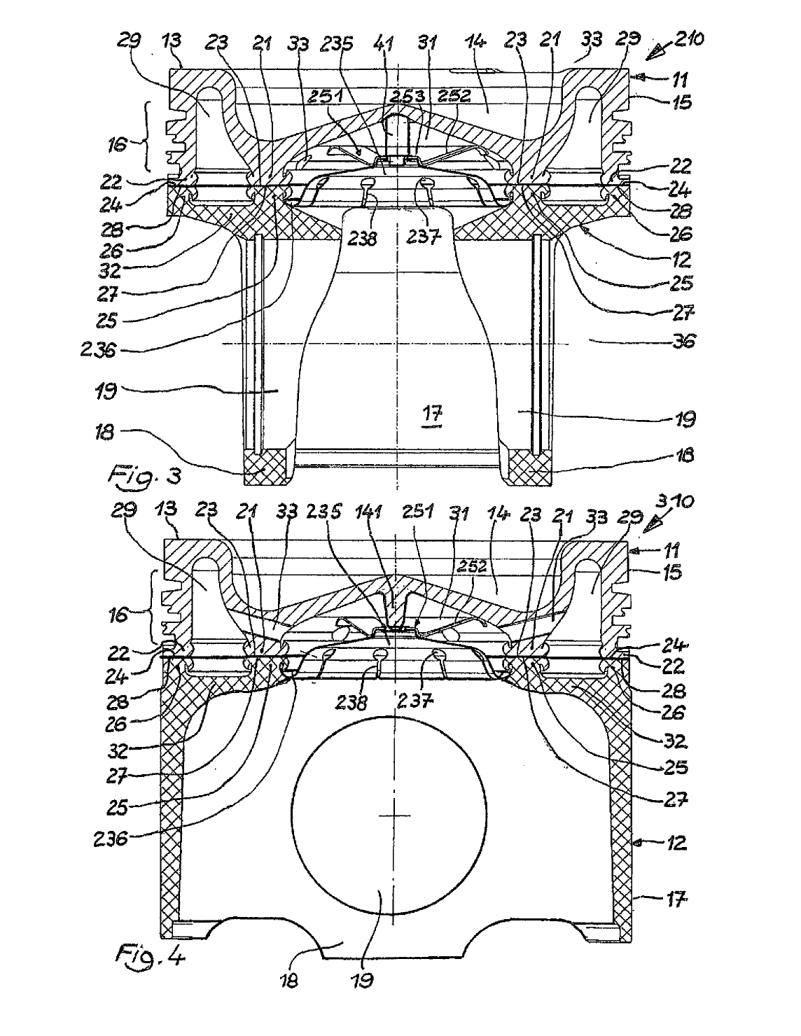

FIGS. 3, 5 and 6 shows another embodiment of a piston 210 according to the invention. Piston 210 essentially corresponds to piston 10 according to FIG. 1, so that structural elements that agree with one another are provided with the same reference numbers.

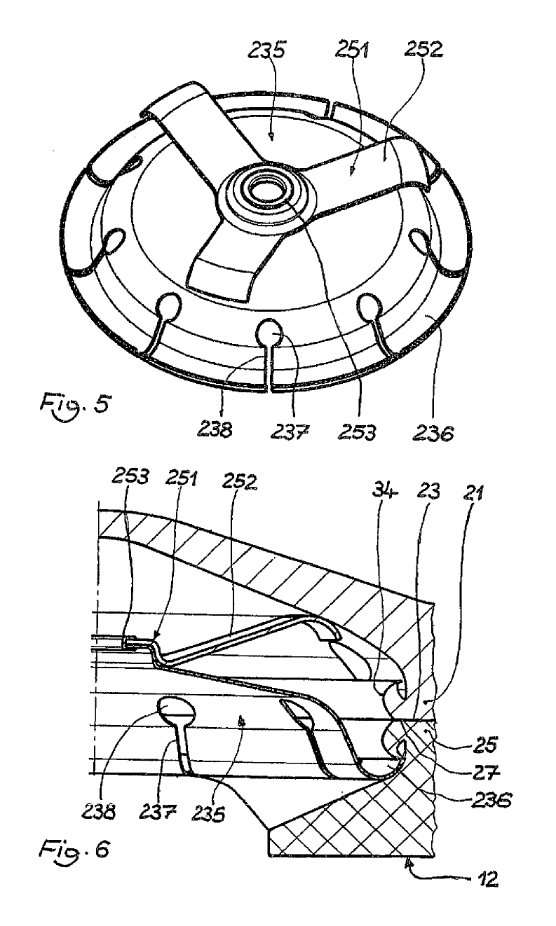

The significant difference consists in the cooling oil collector 235 of the piston 210 according to FIG. 3 disposed in cavity 31. cooling oil collector 235 and its placement in cavity 31 are also shown enlarged in FIGS. 5 and 6.

In this embodiment, cooling oil collector 235 is also produced from a spring steel sheet, has an essentially round shape, is provided with a slight curvature, approximately in the shape of a shallow dome, and has a thickness of about 0.8 mm. In contrast to cooling oil collector 35 according to FIG. 1, cooling oil collector 235 has a circumferential, spring-elastic edge 236 that is bent axially upward. Furthermore, cooling oil openings 237 and slits 238 are provided, which both increase the elasticity of edge 236 in the radial direction, and serve as additional cooling oil openings.

Holding element 41, as described for the piston 10 according to FIG. 1, ensures that cooling oil collector 235 supports itself on inner support element 25 or on pin boss supports 32, under spring bias. In contrast to piston 10 according to FIG. 1, in the embodiment shown here, edge 236 touches the friction-weld bead 34 and supports itself on it, if necessary.

In the embodiment shown here, cooling oil collector 235 is furthermore provided with a support element 251. Support element 251 is configured as a separate component. However, it can also be configured in one piece with cooling oil collector 235, and can be produced by punching it out from cooling oil collector 235, for example. It is practical if support element 251 is also produced from a spring steel sheet, and it has three spring arms 252 that support themselves on the underside of the piston crown 13 of the piston 210 in the assembled state. Spring arms 252 go from a center hub 253, which is attached to cooling oil collector 235 in the longitudinal piston axis. Attachment can take place in any desired manner, for example by means of screwing, riveting, welding, or soldering it on, and the like. It is advantageous if support element 251 is connected with cooling oil collector 235 so that it can rotate. Support element 251 brings about additional spring-elastic securing of the position of cooling oil collector 235 in cavity 31, which is therefore flexibly able to withstand stress during operation.

The function and the assembly of cooling oil collector 235 are the same as described for the cooling oil collector 35.

FIG. 4 shows another embodiment of a piston 310 according to the invention. Piston 310 has the same construction, in essential parts, as piston 210 according to FIG. 3, so that the same structures are provided with the same reference numbers, and reference is made to the description of FIG. 3 with regard to these reference numbers.

The significant difference as compared with the piston 210 according to FIG. 3 is that in the case of the piston 310 of FIG. 4, holding element 141 is formed on, in one piece, onto the underside of piston crown 13, as is also the case in piston 110 according to FIG. 2. In the embodiment of FIG. 4, the length of holding element 141 is dimensioned in such a way that cooling oil collector 235 supports itself on inner support element 25 or on pin boss supports 32 under spring bias. Thus, the cooling oil collector 235 is held in particularly secure and play-free manner.

The inner cooling chamber having a cooling chamber bottom in the form of a wide, radially circumferential ring land, which is required in the state of the art, has therefore been eliminated in all the embodiments.

Accordingly, while only a few embodiments of the present invention have been shown and described, it is obvious that many changes and modifications may be made thereunto without departing from the spirit and scope of the invention.

What is claimed is:

1. A multi-part piston for an internal combustion engine, comprising:
an upper piston part having a piston crown, an inner support element and an outer support element;
a lower piston part having pin boss supports, pin bosses connected with the pin boss supports, an inner support element and an outer support element, wherein the support elements delimit an outer circumferential cooling channel, and the inner support elements delimit a cavity that is open toward the pin bosses; and
a separate cooling oil collector that has at lest one cooling oil opening, said cooling oil collector being disposed in the cavity.

2. The piston according to claim 1, wherein the cooling oil collector is held on or rests on the lower piston part in a region of the inner support element of the lower piston part.

3. The piston according to claim 1, further comprising a holding element that extends vertically in the direction of the lower piston part, from an underside of the piston crown, said holding element being disposed in the cavity, wherein the cooling oil collector supports itself against the holding element, with force fit and/or shape fit, in the axial direction.

4. The piston according to claim 3, wherein the cooling oil collector has a hat-shaped elevation that interacts with the holding element.

5. The piston according to claim 3, wherein the holding element is formed on, in one piece, onto the underside of the piston crown.

6. The piston according to claim 3, wherein the holding element is configured as a separate component from the piston crown and is held on the underside of the piston crown with force fit and/or shape fit.

7. The piston according to claim 3, wherein an end of the holding element projects into the cavity and has a circumferential contact shoulder that surrounds a projection, said shoulder resting on the cooling oil collector, and wherein the projection engages into a bore provided in the cooling oil collector.

8. The piston according to claim 6, wherein the projection is configured as a journal, and the holding element is riveted to the cooling oil collector.

9. The piston according to claim 3, wherein a length of the holding element is dimensioned so that the cooling oil Collector supports itself on the inner support element of the lower piston part or on the pin boss supports.

10. The piston according to claim 1, wherein the cooling oil collector has an at least partially circumferential flange or at least two tongues disposed on an outer edge of the cooling oil collector.

11. The piston according to claim 10, wherein the inner support elements of the upper piston part and the lower piston part are connected with one another by means of a friction welding method that produces friction weld beads, and wherein the flange or tongues are bent axially upward, and touch the friction weld bead or rest against the friction weld bead or engage behind the friction weld bead.

12. The piston according to claim 1, wherein the cooling oil collector has a resilient support element on its side facing the piston crown, said resilient support element supporting itself on an underside of the piston crown.

13. The piston according to claim 12, wherein the support element has at least two spring arms that support themselves on the underside of the piston crown.

14. The piston according to claim 12, wherein the cooling oil collector and the support element are configured in one piece or multiple pieces.

15. The piston according to claim 1, wherein the cooling oil collector is configured as an at least partially spring-elastic component.

16. The piston according to claim 15, wherein the cooling oil collector is produced from a spring steel sheet.

17. The piston according to claim 1, wherein the cooling oil collector is configured to be substantially round.

18. The piston according to claim 1, wherein the cooling oil collector has a curvature.

19. The piston according to claim 1, wherein the at least one cooling oil opening in the cooling oil collector is configured as a slit disposed at an edge of the cooling oil collector.

20. The piston according to claim 1, wherein the cooling oil collector has two or more cooling oil openings.
